(19) United States
(12) Patent Application Publication
(10) Pub. No.: US 2016/0261453 A1
(43) Pub. Date: Sep. 8, 2016

(54) DATA FRAME STRUCTURE AND OPERATION METHOD THEREOF FOR SHARING FREQUENCY AMONG ASYNCHRONOUS CELLS IN WIRELESS COMMUNICATION SYSTEM

(71) Applicant: Electronics and Telecommunications Research Institute, Daejeon (KR)

(72) Inventors: Jung Sun UM, Daejeon (KR); Kyu Min KANG, Daejeon (KR); Jae Cheol PARK, Daejeon (KR); Sung Jin YOO, Daejeon (KR); Dong Hun LEE, Daejeon (KR); Byung Jang JEONG, Daejeon (KR); Hoi Yoon JUNG, Daejeon (KR); Hyung Do CHOI, Daejeon (KR); Sung Hyun HWANG, Daejeon (KR)

(21) Appl. No.: 15/013,522

(22) Filed: Feb. 2, 2016

(30) Foreign Application Priority Data
Mar. 6, 2015 (KR) 10-2015-0031653

(51) Int. Cl. H04L 27/26; H04L 1/18

(52) U.S. Cl. CPC H04L 27/2692; H04L 27/2656; H04L 1/1812

(57) ABSTRACT

When a feature of the present invention is summarized, disclosed is a frame structure of transmitted and received data in a wireless communication system, including: a plurality of uplink subframes (UL) or downlink subframes (DL) for transmitting and receiving data; and a coexistence synchronization signal preamble for frequency coexistence among asynchronous cells.

### CROSS-REFERENCE TO RELATED APPLICATIONS

This application claims priority to and the benefit of Korean Patent Application No. 10-2015-0031653 filed in the Korean Intellectual Property Office on Mar. 6, 2015, the entire contents of which are incorporated herein by reference.

### TECHNICAL FIELD

The present invention relates to a data frame structure and an operation method thereof in a wireless communication system, and more particularly, to a data frame structure in a wireless communication system, which can be operated to share the same frequency resource with a heterogeneous or homogeneous system and an operation method of the system and a terminal and an apparatus of a base station for the operation.

### BACKGROUND ART

In general, a mobile communication system operates in a licensed band in order to assure a QoS of a user. In recent years, a 3GPP standard organization has started a discussion about the use of an unlicensed band (alternatively, spectrum) of a long term evolution (LTE) system.

A 2.4 GHz or 5 GHz band in the unlicensed band is dominantly used by a WiFi system. When the LTE system uses the unlicensed band, a resource allocation method and an interference avoidance function for the coexistence with the WiFi system should be considered.

In the case of WiFi, a carrier sense multiple access (CSMA)/collision avoid (CA) method is used to access a radio resource. On the contrary, since a general LTE system gets a license (approval) for the band in advance, the general LTE system operates based on scheduling.

U.S.A. and Europe have presented a licensed shared access (LSA)/authorized shared access (ASS) concept in order for only a minority of licensed providers to simultaneously use a specific band as a part of a research into utilization of a dynamic frequency.

By considering a trend of common frequency usage, a technical development for the LTE system to share a resource with a heterogeneous system such as the WiFi, or the like or for a homogeneous LTE system, but LTE systems operated by different providers to share the same resource has been required.

In particular, a base station (eNodeB) of the existing LTE system allocates downlink and uplink resources in the licensed band and the resource is managed by a defined time unit (radio frame, subframe, slot, OFDM symbol, or the like). However, when a scenario for sharing the same frequency resource with the heterogeneous or homogeneous system is considered, a radio access technique of the heterogeneous system and frame timing operated by a different provider may be different from each other.

Accordingly, there is a problem in that another system first occupies the resource, and as a result, a radio access opportunity is lost or the resource cannot be efficiently used in the case of aiming at maintaining a fixed time unit. Therefore, a method needs to be developed, which can share the resource even in an environment in which systems are asynchronous with each other.

### SUMMARY OF THE INVENTION

The present invention has been made in an effort to provide a data frame structure which can share the same frequency resource with a heterogeneous or homogeneous system in asynchronous cells and an operation method thereof.

The technical objects of the present invention are not limited to the aforementioned objects, and other technical objects, which are not mentioned above, will be apparent to those skilled in the art from the following description.

When a feature of the present invention is summarized, An exemplary embodiment of the present invention provides a frame structure of transmitted and received data in a wireless communication system, including: a plurality of uplink subframes (UL) or downlink subframes (DL) for transmitting and receiving data; and a coexistence synchronization signal preamble for frequency coexistence among asynchronous cells.

The coexistence synchronization signal preamble may include a first sequence including coexistence synchronization signal information for synchronizing a radio signal, a second sequence including information on the number of the plurality of uplink subframes (UL) or downlink subframes (DL), and a third sequence including index information of a subframe to which a coexistence request signal source for transmitting the coexistence request signal is allocated.

The coexistence synchronization signal preamble may first transmit the first sequence by the time division multiplex (TDM) scheme and multiplex and transmit the second and third sequences to a subcarrier.

The coexistence synchronization signal preamble may transmit the first sequence to the center of a signal bandwidth by the FDM scheme and transmit the second and third sequences to subcarriers of the remaining bands.

Another exemplary embodiment of the present invention provides an operation method for sharing a frequency among asynchronous cells in a wireless communication system including: configuring and transmitting a frame including a coexistence synchronization signal preamble; and transmitting a coexistence request signal for sharing the frequency in an unlicensed band or a limited licensed band among the asynchronous cells through the coexistence synchronization signal preamble.

Transmission of a signal may be stopped for a predetermined time after transmitting the frame to allow another asynchronous cell to use a resource.

In the configuring and transmitting the frame, when the number of subframes constituting a frame transmitted to a cell of the unlicensed band or limited licensed band is a specific number or less, the coexistence request signal may not be allocated.

The coexistence request signal may be transmitted in different sequences to recognize different providers.

The operation method may further include transmitting a response signal to the coexistence request signal after a last subframe of the currently transmitted frame.

When the coexistence request signal is simultaneously transmitted by a plurality of providers, a response signal to a coexistence request may be transmitted to a provider having a priority for a corresponding band or a provider having a small number of subframes to be used in a subsequent frame.

When a downlink or uplink timing in the frame is n, a hybrid auto repeat request (HARQ) timing may be defined as n+5.

According to exemplary embodiments of the present invention, in a data frame structure and an operation method and an operation apparatus thereof in a wireless communication system, which are used to share a frequency among asynchronous cells, a resource can be shared in an asynchronous environment, the existing user can be maximally protected, fairness can be maintained, and a high-quality communication service can be provided in an unlicensed band and a limited licensed band.

The exemplary embodiments of the present invention are illustrative only, and various modifications, changes, substitutions, and additions may be made without departing from the technical spirit and scope of the appended claims by those skilled in the art, and it will be appreciated that the modifications and changes are included in the appended claims.

### BRIEF DESCRIPTION OF THE DRAWINGS

FIG. 1 is a diagram illustrating a basic structure of a frame of a wireless communication system for sharing a frequency among asynchronous cells according to an exemplary embodiment of the present invention.

FIG. 2 is a diagram for describing an example of transmitting the frame of the wireless communication system for sharing the frequency among the asynchronous cells in a time division multiplex (TDM) scheme according to the exemplary embodiment of the present invention.

FIG. 3 is a diagram for describing an example of transmitting the frame of the wireless communication system for sharing the frequency among the asynchronous cells in a frequency division multiplex (FDM) scheme according to the exemplary embodiment of the present invention.

FIG. 4 is a diagram for describing a method for sharing a frequency among asynchronous cells according to another exemplary embodiment of the present invention.

FIG. 5 is a diagram for describing subframe synchronization in a Pcell and a Ucell/Acell according to the exemplary embodiment of the present invention.

FIG. 6 is a diagram for describing the subframe synchronization and hybrid auto repeat request (HARQ) in the Pcell and a Ucell/Acell according to the exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, some exemplary embodiments of the present invention will be described in detail with reference to the exemplary drawings. When reference numerals refer to components of each drawing, it is to be noted that although the same components are illustrated in different drawings, the same components are referred to by the same reference numerals as possible. In describing the exemplary embodiments of the present invention, when it is determined that the detailed description of the known configuration or function related to the present invention may obscure the understanding the exemplary embodiments of the present invention, the detailed description thereof will be omitted.

Terms such as first, second, A, B, (a), (b), and the like may be used in describing the components of the exemplary embodiments of the present invention. The terms are only used to distinguish an element from another element, but nature or an order of the element is not limited by the terms. Further, if it is not contrarily defined, all terms used herein including technological or scientific terms have the same meaning as those generally understood by a person with ordinary skill in the art. Terms which are defined in a generally used dictionary should be interpreted to have the same meaning as the meaning in the context of the related art, and are not interpreted as an ideally or excessively formal meaning unless clearly defined in the present invention.

The present invention relates to a method for an LTE system to efficiently share a resource with a heterogeneous or another LTE system operated by another provider and proposes a frame structure for sharing a resource among asynchronous cells and an associated signal and proposes a procedure for sharing a frequency based thereon. Moreover, a hybrid auto repeat request (HARQ) timing associated with retransmission among the asynchronous cells is defined.

“Asynchronous cell” specified in the present invention means a case in which frame synchronization among multiple cells operated by one base station (NB) does not match under a carrier aggregation environment and a case in which when different base stations (NB) operate cells at the same frequency, respectively, the frame synchronization among the cells does not match.

Radio resources considered in the present invention are divided into three categories of a licensed band which is a band allocated to each mobile communication system (public land mobile network (PLMN)), an unlicensed band which is a band in which a WiFi (wireless LAN) system operates, and a limited licensed band (licensed shared access (LSA)/authorized shared access (ASS)) which is a band which is preferentially allocated to the existing specific system such as a radar, but not regionally used and may be shared by licensed mobile communication providers.

A carrier in which a service is provided in each band is defined as a cell. Further, a cell in which a terminal (UE) first accesses a network in the licensed band is defined as a primary cell (PCell) and additionally, a cell allocated (activated) by the base station (NB) is defined as a secondary cell (SCell). In addition, a carrier in the unlicensed band is defined as an unlicensed cell (UCell) and a carrier in the limited licensed band (licensed shared access (LSA)/authorized shared access (ASS)) is defined as an authorized cell (ACell).

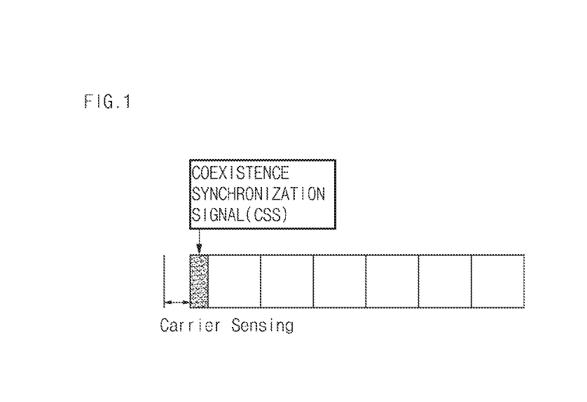

Hereinafter, a data frame structure and an operation method and an operation apparatus thereof in a wireless communication system, which are used to share a frequency among asynchronous cells according to exemplary embodiments of the present invention will be described with reference to FIGS. 1 to 6.

FIG. 1 is a diagram illustrating a basic structure of a frame of a wireless communication system for sharing a frequency among asynchronous cells according to an exemplary embodiment of the present invention.

In a CA scenario of 3GPP Rel.-11/12, a base station (NB) synchronizes with a Pcell to operate a Scell. A terminal (UE) also applies a DL synchronization result acquired by PSS/SS to the Pcell to the Scell and applies a result of acquiring UL timing advance (TA) by transmitting a physical random access channel (PRACH) to the Scell. As a result, radio frames and subframes of all of the Pcells and the Scells may be operated by synchronizing with each other. However, in the case of a Ucell and an Acell, since a DL/UL transmission timing is determined according to a situation in which another heterogeneous or homogeneous system accesses a resource, it is difficult to accurately match the subframe of the Pcell and a start timing with each other.

Therefore, the present invention proposes a frame structure including a coexistence synchronization signal (CSS) for synchronization in the Ucell and the Acell in the wireless communication system, which is used to share the frequency among the asynchronous cells.

Referring to FIG. 1, a frame structure (alternatively, a structure body) of communication data loaded on a signal or a packet, which may be used in the wireless communication system according to an exemplary embodiment of the present invention is constituted by a plurality of arranged subframes and each of the subframes may be constituted by an uplink subframe zone (UL zone) and a downlink subframe zone (DL zone). The frame is configured to include the coexistence synchronization signal (CSS) before a first transmitted subframe and include a coexistence signal resource (CoSR) for transferring the coexistence signal (CoS). In this case, a position of the coexistence signal resource (CoSR) may vary for each provider, or the like.

That is, a carrier sensing process is required, which senses whether the base station (NB) and/or terminal (UE) occupies the resource in association with a function additionally required to share the Ucell and the Acell. An automatic gain control operates to suit a situation (signal level) of a radio channel according to a carrier sensing result. Therefore, the coexistence synchronization signal (CSS) for the AGC and time synchronization is required before a set of consecutive subframes configured and transmitted in the Ucell/Acell. Even when the frame is configured by sensing only the base station (NB) to be initially transmitted, since the terminal (UE) may not know when a downlink is to be transmitted, the terminal (UE) receives a signal through a reception path (Rx path). Therefore, the coexistence synchronization signal (CSS) is similarly configured at a head of the subframe set transmitted each time as illustrated in FIG. 1.

The coexistence synchronization signal (CSS) is constituted by sequence 1 Seq1, sequence 2 Seq2, and sequence 3 Seq3. The sequence 1 Seq1 which is used for basic synchronization includes a synchronization signal for the AGC and time/frequency synchronization. The sequence 1 may be configured for each provider and transferred to the terminal (UE) through an RRC message of the Pcell and the terminals (UE) may detect whether a corresponding frame is a frame transmitted from a connected base station (NB) through the sequence 1. Further, the terminals (UE) connected to the Pcell may detect only the sequence 1 without the need of detecting the sequence 2 or the sequence 3.

The sequence 2 Seq2 represents the number of consecutive subframes included in the frame and the sequence 3 Seq3 includes a position of a subframe which may transmit a signal for frequency coexistence. That is, the coexistence request signal (CoS) which the base station (NB) or the terminal (UE) of another provider transmits for coexistence is transmitted through the subframe designated by the sequence 3. The resource is allocated to a signal transmitted to another subcarrier such as a PRACH signal of LTE to minimize an ICI.

In the present invention, it is assumed that a subframe unit of current LTE is used as a basic unit of synchronization among cells as an exemplary embodiment. However, the basic unit may be a smaller unit or a larger unit than the subframe.

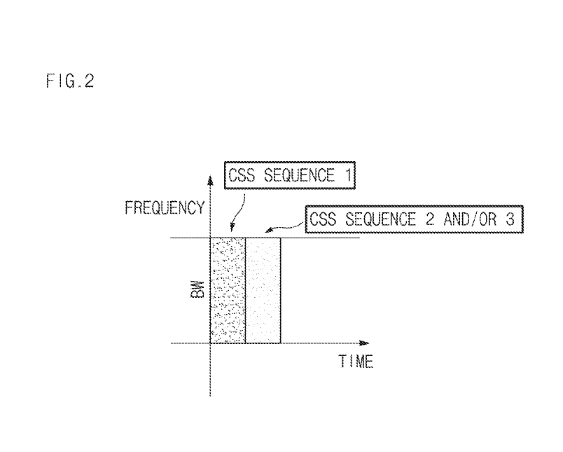

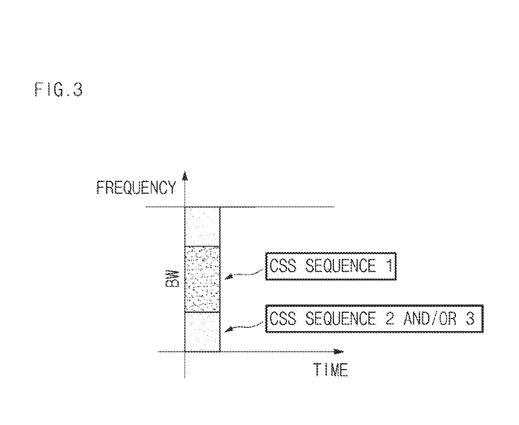

The coexistence synchronization signal (CSS) is transmitted by a time division multiplex scheme or a frequency division multiplex scheme and hereinafter, a transmission scheme of the coexistence synchronization signal will be described in detail with reference to FIGS. 2 and 3.

FIG. 2 is a diagram for describing an example of transmitting the frame of the wireless communication system for sharing the frequency among the asynchronous cells in a time division multiplex (TDM) scheme according to the exemplary embodiment of the present invention.

Referring to FIG. 2, the frame is transmitted with an entire signal bandwidth by the TDM scheme and the sequence 1 is deployed on the head and the sequence 2 and the sequence 3 are integrated into one to be transmitted or the sequence 2 and/or the sequence 3 may be arranged and transmitted in sequence.

FIG. 3 is a diagram for describing an example of transmitting the frame of the wireless communication system for sharing the frequency among the asynchronous cells in a frequency division multiplex (FDM) scheme according to the exemplary embodiment of the present invention.

Referring to FIG. 3, when a signal bandwidth (BW) is sufficient, the sequence 1 is transmitted to the center of the signal bandwidth and the sequence 2 and/or the sequence 3 may be multiplexed and transmitted to a residual band.

A transmission scheme of the coexistence synchronization signal and a configuration thereof may vary depending on a bandwidth of a carrier which may be used as the Ucell/Acell and notified to an RRC connected terminal (UE) through the RRC message of the Pcell. In the case of another PLMN, a configuration format of the coexistence synchronization signal may be detected by a simple correlation scheme and may also be detected according to a configuration method of transmitting the sequence 1.

As an exemplary embodiment, a method that allocates the sequence 1 to the subcarrier may be divided into a method using a low subcarrier and a method using a high subcarrier and may be based on a method that transmits the sequence 1 by the FDM scheme and since the time synchronization with the AGC may be performed by only the sequence 1 of the terminal (UE) connected to the base station (NB) that transmits data to the current Ucell/Acell, the number of OFDM symbols used to transmit the residual sequences 2 and 3 other than the sequence 1 may be decreased, thereby increasing overall resource usage efficiency.

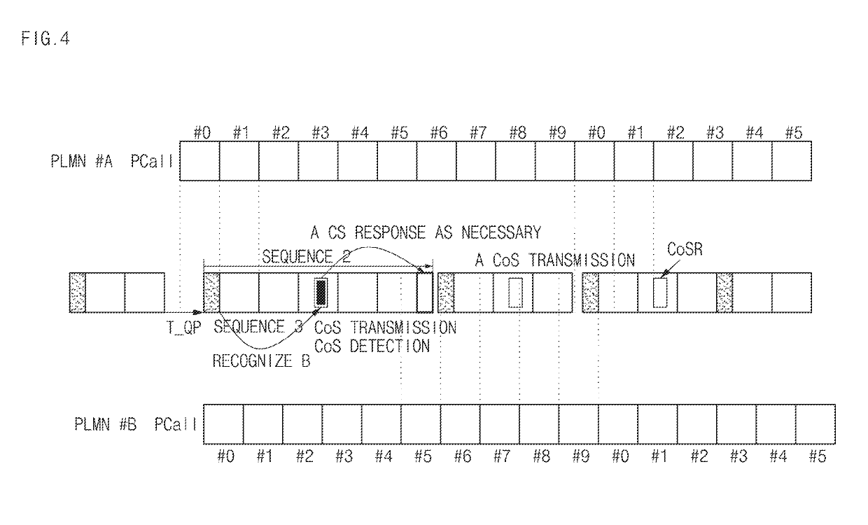

FIG. 4 is a diagram for describing a method for sharing a frequency among asynchronous cells according to another exemplary embodiment of the present invention.

Referring to FIG. 4, when the terminal (UE) that is using a PLMN #A Pcell intends to use a resource of the Ucell or Acell, the terminal (UE) transmits the coexistence request signal (CoS) through the coexistence request signal source (CoSR) of the frame transmitted to the Ucell or Acell. In this case, when the number of subframes constituting the frame transmitted to the Ucell or Acell is a specific number or less, the coexistence request signal source (CoSR) may not be allocated.

In the present invention, the coexistence request signal source (CoSR) may be configured by a predefined PRB and symbol. In this case, the base station (NB) and the terminal (UE) of another provider may transmit the coexistence request signal only by detecting a subframe index. The coexistence request signal source (CoSR) is configured by considering a time required for another provider to detect the sequence 3 and a time for a provider which operates currently to determine whether to transmit or yield a subsequent frame by detecting the coexistence request signal. Therefore, when the frame is constituted by subframes of a predetermined number or less, the sequence 3 may not be transmitted and the coexistence request signal source may not be allocated. When the number of subframes is small as described above, since the PLMN using the current Ucell/Acell means that resources to be transmitted to the Ucell/Acell are not so a lot, the resource may be transmitted after a minimum transmission pause length defined after transmitting the frame. In this case, when another PLMN first detects a pause interval and first transmits the interval, resource occupation is handed over to another PLMN.

Sequences included in the coexistence request signal transmitted to the coexistence request signal source (CoSR) may be allocated differently for respective providers and the sequence 1 transmitted in each PLMN may be reused. Further, a provider that requests sharing may notify the number of subframes to be used in a subsequent frame. In the case of the information, an additional sequence may be included in the coexistence request signal and transmitted or cyclic shifted and transmitted.

In transmitting a usable sequence, when different PLMNs simultaneously request sharing to the coexistence request signal source, the PLMN that uses the current resource may notify the PLMN that requests a small number of resources to a PLMN that intends to use a small number of subframes to other PLMNs that simultaneously transmit the coexistence request signal.

The coexistence request signal is additionally transmitted after a last subframe of a current frame to be notified to the PLMNs that simultaneously transmit the coexistence request signal to the coexistence request signal source. The assumption is used to first grant a priority to the PLMN that requests a small number of frames and thereafter, in the case of the resource occupation, the PLMN may sequentially occupy the resources according to a coexistence collision scenario.

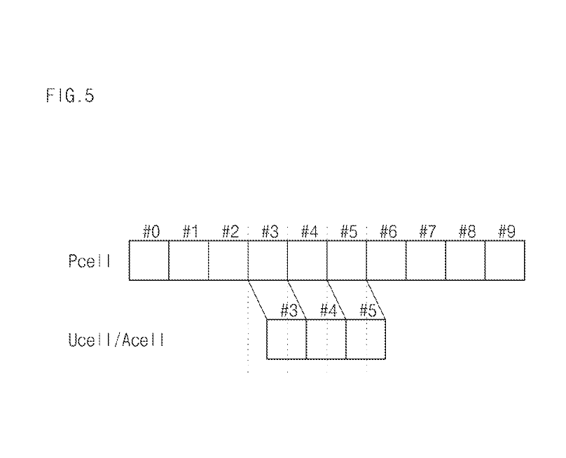

FIG. 5 is a diagram for describing subframe synchronization in a Pcell and a Ucell/Acell according to the exemplary embodiment of the present invention.

When the subframe is asynchronized, the subframe index of the Ucell/Acell which is cross-scheduled may be unclear. Further, a processing time for downlink subframe (DL)/uplink subframe (UL) HARQ may be insufficient and an accurate index of n+4 may be unclear. In particular, since the DL HARQ is defined in a CA operation mode so as to be transmitted to only the Pcell, accurate Pcell UL designation for DL of the Ucell/Acell is required.

Therefore, the present invention presents logical subframe synchronization. As an exemplary embodiment, as illustrated in FIG. 5, a Pcell subframe index at a position at which a start position of the Ucell/Acell subframe starts is assumed as the subframe index of the Ucell/Acell. In this case, the subframe index is accurately clarified in the Ucell/Acell subframe to be transmitted from the base station (NB) and/or the terminal (UE). Alternatively, the subframe index is not transmitted, but the base station (NB)/the terminal (UE) may match the subframe indexes each other assumptively and tacitly.

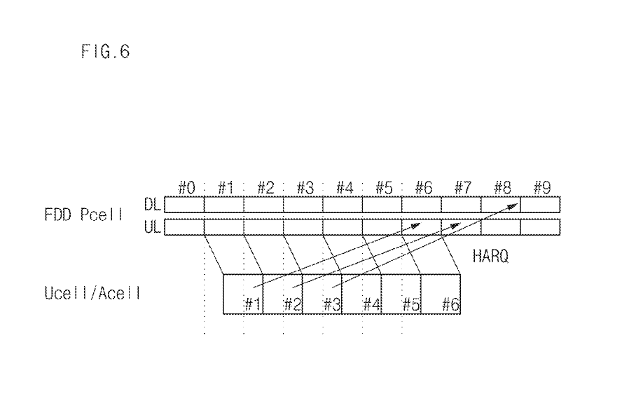

FIG. 6 is a diagram for describing the subframe synchronization and hybrid auto repeat request (HARQ) in the Pcell and a Ucell/Acell according to the exemplary embodiment of the present invention.

A HARQ timing is based on n+5 by considering asynchronization and a data decoding time of the subframe based on the synchronization of the logical subframe. A basic HARQ timing of ACK/NAC for UL/DL of the Ucell and the Acell transmitted to the DL/UL of the Pcell may be determined as n+5.

The technical spirit of the present invention has been just exemplarily described in the above description, and various changes and modifications may be made by those skilled in the art to which the present invention pertains without departing from intrinsic characteristics of the present invention.

Accordingly, the exemplary embodiments disclosed herein are intended not to limit but to describe the technical spirit of the present invention, and the scope of the spirit of the present invention is not limited to the exemplary embodiments. The scope of the present invention should be interpreted by the appended claims, and all the technical spirit in the equivalent range should be interpreted to be embraced in the scope of the present invention.

What is claimed is:

1. A frame structure of transmitted and received data in a wireless communication system, comprising:
a plurality of uplink subframes (UL) or downlink subframes (DL) for transmitting and receiving data; and
a coexistence synchronization signal preamble for frequency coexistence among asynchronous cells.

2. The frame structure of claim 1, wherein the coexistence synchronization signal preamble includes
a first sequence including coexistence synchronization signal information for synchronizing a radio signal,
a second sequence including information on the number of the plurality of uplink subframes (UL) or downlink subframes (DL), and
a third sequence including index information of a subframe to which a coexistence request signal source for transmitting the coexistence request signal is allocated.

3. The frame structure of claim 2, wherein the coexistence synchronization signal preamble first transmits the first sequence by a time division multiplex (TDM) scheme and multiplexes and transmits the second and third sequences to a subcarrier.

4. The frame structure of claim 2, wherein the coexistence synchronization signal preamble transmits the first sequence to the center of a signal bandwidth by a frequency division multiplex (FDM) scheme and transmits the second and third sequences to subcarriers of the remaining bands.

5. An operation method for sharing a frequency among asynchronous cells in a wireless communication system, the method comprising:
configuring and transmitting a frame including a coexistence synchronization signal preamble; and
transmitting a coexistence request signal for sharing the frequency in an unlicensed band or a limited licensed band among the asynchronous cells through the coexistence synchronization signal preamble.

6. The operation method of claim 5, wherein transmission of a signal is stopped for a predetermined time after transmitting the frame to allow another asynchronous cell to use a resource.

7. The operation method of claim 5, wherein in the configuring and transmitting the frame, when the number of subframes constituting a frame transmitted to a cell of the unlicensed band or limited licensed band is a specific number or less, the coexistence request signal is not allocated.

8. The operation method of claim 5, wherein the coexistence request signal is transmitted in different sequences to recognize different providers.

9. The operation method of claim 5, further comprising:
transmitting a response signal to the coexistence request signal after a last subframe of the currently transmitted frame.

10. The operation method of claim 5, wherein when the coexistence request signal is simultaneously transmitted by a plurality of providers, a response signal to a coexistence request is transmitted to a provider having a priority for a corresponding band or a provider having a small number of subframes to be used in a subsequent frame.

11. The operation method of claim 5, wherein when a downlink or uplink timing in the frame is n, a hybrid auto repeat request (HARQ) timing is defined as n+5.
